(19) United States
(12) Patent Application Publication
(10) Pub. No.: US 2013/0344969 A1
(43) Pub. Date: Dec. 26, 2013

(54) GEARLESS DRIVE FOR A DRIVING DRUM OF A BELT CONVEYOR PLANT

(71) Applicant: ABB Schweiz AG, Baden (CH)

(72) Inventors: Hanspeter ERB, Spiez (CH); Urs MAIER, Aristau (CH)

(73) Assignee: ABB Schweiz AG, Baden (CH)

(21) Appl. No.: 13/974,806

(22) Filed: Aug. 23, 2013

Related U.S. Application Data
(63) Continuation of application No. PCT/EP2012/052595, filed on Feb. 15, 2012.

(30) Foreign Application Priority Data
Feb. 23, 2011 (EP) 11155619.7

(51) Int. Cl. F16D 9/06

(52) U.S. Cl. CPC F16D 9/06
USPC 464/33; 464/179

(57) ABSTRACT

Exemplary embodiments of the disclosure provide a gearless drive with a bearing-free rotor shaft for a driving drum of a belt conveyor plant. The gearless drive includes a support. The support is positioned such that it forms a horizontal repository for the rotor shaft in the event of separation between the rotor shaft and a drum shaft connected to the driving drum, without the rotor touching the stator, and such that said support does not touch the rotor shaft in the event of connection between the rotor shaft and drum shaft.

This application claims priority as a continuation application under 35 U.S.C. §120 to PCT/EP2012/052595, which was filed as an International Application on Feb. 15, 2012, designating the U.S., and which claims priority to European Application 11155619.7, filed in Europe on Feb. 23, 2011. The content of each prior application is hereby incorporated by reference in its entirety.

### FIELD

The present disclosure relates to the field of belt conveyor plants, and particularly to a gearless drive for a driving drum of a belt conveyor plant, with a rotor, with a bearing-free rotor shaft connected to the rotor and with a stator arranged around the rotor on the outside, the rotor shaft being connectable to a drum shaft connected to the driving drum.

### BACKGROUND INFORMATION

Known belt conveyor plants, which may also be designated as conveyor band plants or band conveyors, are used for the transport of lumpy or bulk material in mining and in industry. As disclosed in DE 847,427, an endless belt is mounted so that it rolls horizontally and is driven by a driving drum which is set in rotational movement by a drive.

Belt conveyor plants are often employed in continuously running processes, such as, for example, in the open-cast mining of ore-bearing rock by means of a bucket wheel excavator. Stoppage times on account of malfunctions of a belt conveyor plant should therefore be minimized, because, in such a case, the overall process cannot be continued and costly production outage times occur. One of the main causes of malfunctions of a belt conveyor plant is a failure of wearing parts. Many of these wearing parts are located in the drive of the belt conveyor plant, where there is a large number of moving parts because of the use of clutches and gears. The number of wearing parts should therefore be reduced to a minimum in order to maximize the mean operating time between outages.

Gearless drives are known, above all, for larger belt conveyor plants which can have a drive power of more than 2 MW. In this case, a rotor of a gearless drive is attached directly to a rotor shaft which has rotor shaft bearings at both ends and is connected flexibly to the driving drum. As a counterpiece, a stator, which is connected to a foundation, is arranged around the rotor on the outside. This solution does not use any clutch or any gear, but has two additional rotor shaft bearings as further wearing parts.

The Siemens brochure “Advanced Drive System Saves up to 20% Energy” describes a belt conveyor plant with a gearless drive for a driving drum without any additional rotor bearing. The mounting or maintenance of the driving drum and drive is consequently highly complicated, because the drive cannot simply be separated from the driving drum. When the driving drum is to be demounted, the entire gearless drive likewise has to be demounted.

### SUMMARY

An exemplary gearless drive for a driving drum of a belt conveyor plant is disclosed, the drive comprising: a rotor, with a bearing-free rotor shaft connected to the rotor and with a stator arranged around the rotor on the outside, the rotor shaft being connectable to a drum shaft connected to the driving drum; and a support which, in the event of separation between the rotor shaft and drum shaft, supports the rotor shaft, without allowing direct contact between the rotor and the stator, and which, in the event of connection between the rotor shaft and drum shaft, does not touch the rotor shaft.

An exemplary method for protecting a belt conveyor plant, which has a driving drum, a drum shaft, and a bearing-free drive shaft, against moment peaks, is disclosed the method comprising: connecting the drum shaft and rotor shaft via a shear bolt; and supporting the rotor shaft after the shear bolt is broken.

### BRIEF DESCRIPTION OF THE DRAWINGS

The disclosure is explained in more detail below by means of an exemplary embodiment, in conjunction with the Figures in which:

FIG. 1 shows a driving drum with a gearless drive in a section in the axial direction according to an exemplary embodiment of the disclosure;

FIG. 2 shows a support in a section in the radial direction according to an exemplary embodiment of the disclosure; and

FIG. 3 shows a radial support in a section in the radial direction according to an exemplary embodiment of the disclosure.

The reference symbols used in the drawings are gathered together in the list of reference symbols. Identical parts are basically given the same reference symbols.

### DETAILED DESCRIPTION

Exemplary embodiments of the present disclosure provide simple separation between a gearless drive having a bearing-free rotor shaft and a driving drum of a belt conveyor plant.

According to exemplary embodiments described herein, a support, which may also be designated as a mount, is present with the effect of a mechanical rest or loose bearing. The support is positioned such that it forms a horizontal repository for the rotor shaft in the event of separation between the rotor shaft and drum shaft, without the rotor touching the stator, and such that said support does not touch the rotor shaft in the event of connection between the rotor shaft and drum shaft.

In an exemplary embodiment, a radial support with the effect of a short mechanical cross bearing, which radial support supports the rotor shaft in the event of separation between the rotor shaft and drum shaft in a rotational movement about an axis of the rotor shaft, without the rotor touching the stator, and does not touch the rotor shaft in the event of connection between the rotor shaft and drum shaft. This also makes it possible to have control of the rotor shaft after separation between the rotor shaft and drum shaft during operation, for example, during a rotational movement about an axis of the rotor shaft.

In another exemplary embodiment, a radial support has a radially inner running surface made from bronze. It thereby becomes possible to produce a maintenance-free self-lubricating radial support in a simple way.

Still another exemplary embodiment of the present disclosure refers to a vertically adjustable support, in which a supporting surface can be raised vertically by an amount corresponding to the distance between the support and the rotor shaft. Mounting and demounting of the rotor shaft without the use of a crane thereby becomes possible.

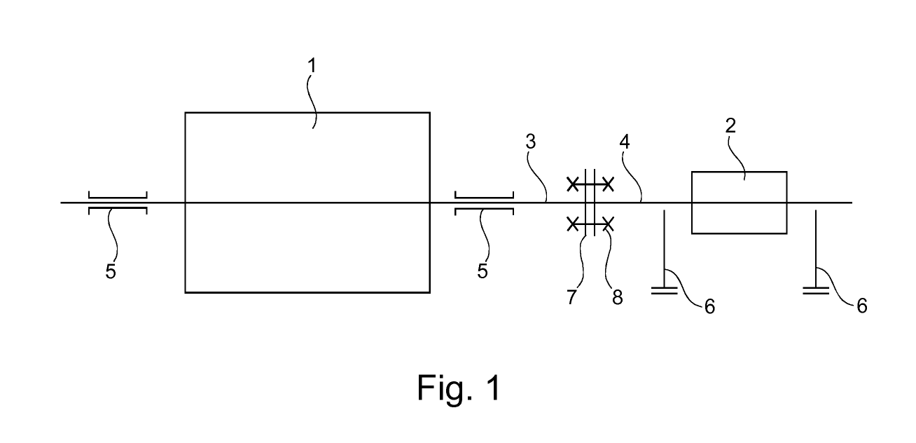

FIG. 1 shows a driving drum with a gearless drive in a section in the axial direction according to an exemplary embodiment of the disclosure. FIG. 1 shows a driving drum 1 of a belt conveyor plant and a gearless drive in a section in the axial direction transversely to the belt running direction. The driving drum 1 rotates about its axis of rotation on a drum shaft 3 which is guided on both sides by drum shaft bearings 5. The drum shaft 3 is connectable to a bearing-free rotor shaft 4 via a flange 7. A rotor 2 is located on the rotor shaft 4. A stator, which is not illustrated in FIG. 1, is arranged as a counterpiece around the rotor 2 on the outside. There is a radial distance, which can amount to between 10 and 18 mm, between the stator and the rotor 2. In the event of connection between the rotor shaft 4 and drum shaft 3, these two shafts form a unit and are guided radially in their rotational movement solely by the drum shaft bearings 5. The drive includes (e.g., comprises) a support 6 on each of the two sides of the rotor 2.

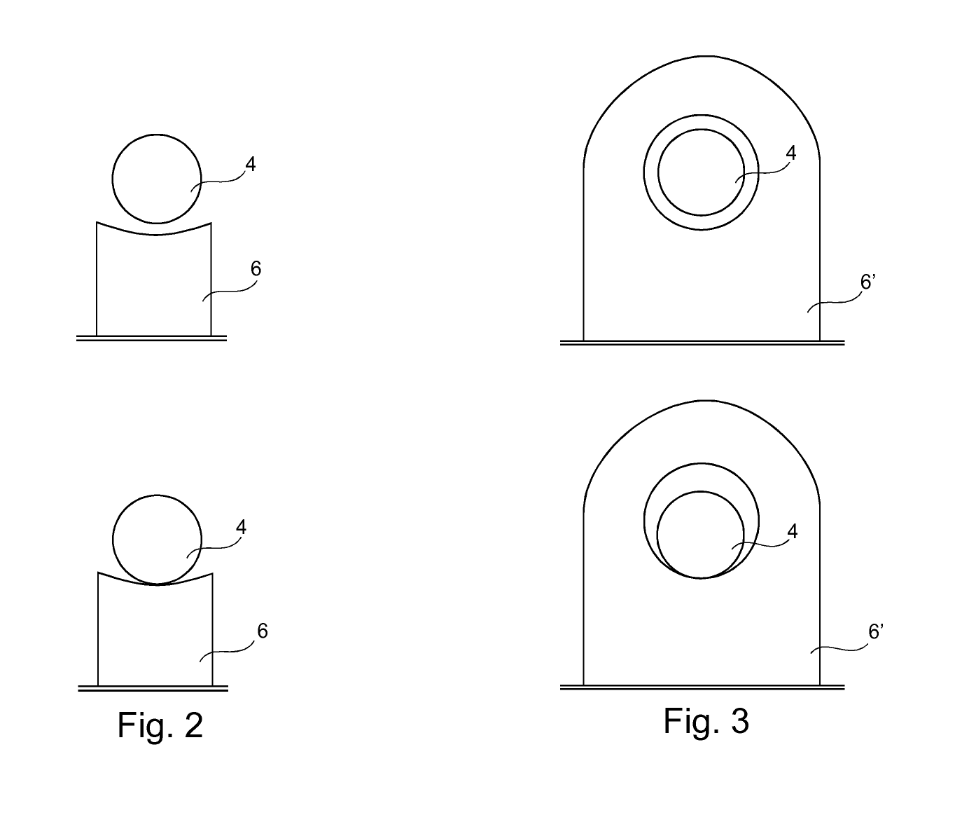

FIG. 2 shows a support in a section in the radial direction according to an exemplary embodiment of the disclosure. FIG. 2 shows a section through one of the supports 6 in FIG. 1 in the radial direction transversely to the rotor shaft 4. The upper part of FIG. 2 illustrates the mutual position of the support 6 and of the rotor shaft 4 in the event of connection between the rotor shaft 4 and drum shaft 3. There is a vertical distance, which is smaller than the distance between the stator and the rotor 2, between the support 6 and the rotor shaft 4. In the event of separation between the rotor shaft 4 and drum shaft 3, the rotor shaft 4 is no longer guided by the drum shaft bearings 5. In this case, which is illustrated in the lower part of FIG. 2, the two supports 6 support the rotor shaft 4, without allowing touch contact between the rotor 2 and stator.

The connection between the rotor shaft 4 and drum shaft 3 does not have to be made via a flange. Other component connections, such as, for example, a pin connection, may also be used. The number of supports 6 may vary. Even one support can guide the rotor shaft 4 if it is suitable for absorbing a resultant tilting moment transversely to the axial direction of the rotor shaft 4. However, arrangements of a plurality of supports 6 can be advantageous if a center of gravity of the rotor shaft 4 is located within the two axially outermost supports 6, since no resultant tilting moment occurs in this case. The form of the support may also deviate from what is illustrated in FIG. 2. Any form is suitable, as long as it makes it possible to have a stable repository of the rotor shaft 4. In this case, additional elements, such as ropes, pins or clips, may also be used for stabilization.

The drive does not have to be a gearless drive. It is also possible to use a geared drive which has a bearing-free shaft. The application is not restricted to belt conveyor plants either, but may also encompass all gearless drive systems with a bearing-free shaft, such as, for example, mine conveyor plants, link conveyor plants, mills or ropeways, but also ship's drives or windmills. In this case, the drive may also be oriented vertically.

FIG. 3 shows a radial support in a section in the radial direction according to an exemplary embodiment of the disclosure. FIG. 3 shows a radial support 6′ in a section in the radial direction transversely to the rotor shaft 4 with a radially inner running surface made from bronze which is arranged approximately concentrically about the rotor shaft 4 in the event of connection between the rotor shaft 4 and drum shaft 3. Between the radial support 6′ and rotor shaft 4 there is a distance which is smaller than the distance between the stator and the rotor 2. It can be advantageous to make the distance between the radial support 6′ and rotor shaft 4 as small as possible, without operational tolerances in this case leading to touch contact between the radial support 6′ and rotor shaft 4. The distance can amount to between 1 and 4 mm. In the event of separation between the rotor shaft 4 and drum shaft 3, which, in contrast to an arrangement that has a support 6 according to FIG. 2, may take place not only during a standstill of the two shafts, but also during a rotational movement of these, the rotor shaft 4 is temporarily supported radially by two radial supports 6′, without touch contact between the rotor 2 and stator being permitted. Because of the self-lubricating action of bronze, the running surface made from bronze reduces frictional load between the running surface and rotor shaft 4 in the event of radial support during a rotational movement of the rotor shaft 4.

In the exemplary embodiment according to FIG. 3, the connection between the rotor shaft 4 and drum shaft 3 at the flange 7 can be made via a shear bolt 8 which breaks in the event of the occurrence of too high a torsional moment in the flange connection and which thus separates the connection between the rotor shaft 4 and drum shaft 3. For example, due to a short circuit in the drive, load peaks may temporarily arise in the rotor shaft 4 which are higher than the loads during normal operation. The result of these load peaks is that, in the absence of separation, these may be transmitted to the belt conveyor plant and may lead to considerable damage such as, for example, the tearing of a belt. If separation occurs because of such a load peak while the rotor shaft 4 and drum shaft 3 are rotating, the rotor shaft 4 is supported radially by the radial support 6′ after separation.

Instead of the shear bolt 8, other predetermined breaking points may also be provided, which fail when a specific load is overshot and which consequently separate the connection between the rotor shaft 4 and drum shaft 3. Nor does the predetermined breaking point have to be positioned at the flange 7, but may also be shifted further in the direction of the drum shaft bearing facing the connection or of the support facing the connection. It is important merely that the part separated by the predetermined breaking point has a center of gravity which is located within the supports 6. A radial support 6′ may also be used without a predetermined breaking point. However, the presence of the predetermined breaking point is advantageous, since this ensures that the belt conveyor plant is protected against moment peaks. The radial bearing does not have to be arranged concentrically about the rotor shaft 4. In the case of a nonconcentric arrangement, the maximum distance between the radial support 6′ and rotor shaft 4 should be smaller than the smallest distance between the stator and the rotor 2. In addition to the rotor shaft 4 being supported radially, it may also have axial support which can be advantageous when synchronous machines are used, since, during operation, these have no magnetic guidance in the axial direction as a result of interaction between the rotor 2 and the stator. To reduce the frictional load, instead of the running surface made from bronze, other materials, for example other metals or plastics, such as, for example, Teflon, or other bearing-like structural principles, such as, for example, a ball-mounted inner ring having a distance from the rotor shaft 4, may also be used.

Thus, it will be appreciated by those skilled in the art that the present invention can be embodied in other specific forms without departing from the spirit or essential characteristics thereof. The presently disclosed embodiments are therefore considered in all respects to be illustrative and not restricted. The scope of the invention is indicated by the appended claims rather than the foregoing description and all changes that come within the meaning and range and equivalence thereof are intended to be embraced therein.

### LIST OF REFERENCE SYMBOLS

1 Driving drum
2 Rotor
3 Drum shaft
4 Rotor shaft
5 Drum shaft bearing
6 Support
6′ Radial support
7 Flange
8 Shear bolt

What is claimed is:

1. A gearless drive for a driving drum of a belt conveyor plant, the drive comprising:
a rotor, with a bearing-free rotor shaft connected to the rotor and with a stator arranged around the rotor on the outside, the rotor shaft being connectable to a drum shaft connected to the driving drum; and
a support which, in the event of separation between the rotor shaft and drum shaft, supports the rotor shaft, without allowing direct contact between the rotor and the stator, and which, in the event of connection between the rotor shaft and drum shaft, does not touch the rotor shaft.

2. The gearless drive as claimed in claim 1, wherein the support is a radial support which, in the event of separation between the rotor shaft and drum shaft, supports the rotor shaft radially during a rotational movement, without allowing direct contact between the rotor and the stator, and, in the event of connection between the rotor shaft and drum shaft, does not touch the rotor shaft.

3. The gearless drive as claimed in claim 2, wherein the radial support has a running surface made from bronze.

4. The gearless drive as claimed in claim 1, wherein the rotor shaft is connectable to the drum shaft, a predetermined breaking point at the same time being formed.

5. The gearless drive as claimed in claim 1, wherein the support is vertically adjustable.

6. The gearless drive as claimed in claim 2, wherein the rotor shaft is connectable to the drum shaft, a predetermined breaking point at the same time being formed.

7. The gearless drive as claimed in claim 2, wherein the support is vertically adjustable.

8. The gearless drive as claimed in claim 3, wherein the rotor shaft is connectable to the drum shaft, a predetermined breaking point at the same time being formed.

9. The gearless drive as claimed in claim 3, wherein the support is vertically adjustable.

10. The gearless drive as claimed in claim 4, wherein the support is vertically adjustable.

11. The gearless drive as claimed in claim 6, wherein the support is vertically adjustable.

12. The gearless drive as claimed in claim 8, wherein the support is vertically adjustable.

13. A method for protecting a belt conveyor plant, which has a driving drum, a drum shaft and a bearing-free drive shaft, against moment peaks, the method comprising:
connecting the drum shaft and rotor shaft via a shear bolt; and
supporting the rotor shaft after the shear bolt is broken.

14. The method as claimed in claim 13, comprising:
supporting the rotor shaft radially during a rotational movement after the shear bolt is broken.
